(19) United States
(12) Patent Application Publication
(10) Pub. No.: US 2015/0120245 A1
(43) Pub. Date: Apr. 30, 2015

(54) GENERATING DATA MANIPULATION TOOLS USING PREDICTIVE ANALYSIS CHAINS

(71) Applicants: Rakesh Kelappan, Walldorf (DE); Vishwanath Belur, Walldorf (DE)

(72) Inventors: Rakesh Kelappan, Walldorf (DE); Vishwanath Belur, Walldorf (DE)

(21) Appl. No.: 14/066,165

(22) Filed: Oct. 29, 2013

(51) Int. Cl. G06F 17/18; G06F 3/0484; G06F 3/0482

(52) U.S. Cl. CPC G06F 17/18; G06F 3/0482; G06F 3/04842
USPC 702/179

(57) ABSTRACT

A custom data manipulation tool may be created that allows a user to perform one or more statistical analysis steps with reduced configuration. A statistical analysis process chain is exported as a data manipulation tool that allows a user to later execute the statistical algorithm with minimal inputs. Rather than setting up a new statistical analysis process chain every time a user wishes to perform statistical analysis on a set of data, the user may use the previously configured and stored data manipulation tool to perform the statistical analysis.

### BACKGROUND

Statistical analysis may be performed by a user using a predictive analysis application. The predictive analysis application may be used to acquire data from a number of data sources (e.g., databases, .csv files, spreadsheet files, etc.) and to manipulate the data (e.g., format, group, filter, etc.) to prepare the data for analysis. The predictive analysis application may then apply one or more statistical algorithms (e.g., in series) to predict future values of the data and to generate one or more visuals (e.g., graphs, charts, etc.) to display the results.

The predictive analysis application may be used by a statistician or other expert familiar with the statistical algorithms used to project and generate results. The application may provide the statistical algorithms to the user as components that can be linked together by the application to form a statistical analysis process chain. Each component is a logic unit in the statistical analysis process chain that does a specific job or function. Each component has a predefined set of properties that the user may set according to his or her analysis requirements. The user may select which components relevant to the analysis.

Conventional predictive analysis applications often require that the user have statistical expertise when setting the set of properties for the statistical algorithms. For different datasets, the user may need to revisit and change settings or properties relating to a component in the statistical analysis process chain. This process may be more difficult for a user (e.g., a business user) with less expertise in statistics or less familiarity with the algorithms used. Some predictive analysis applications may provide a specific list of algorithms or statistical workflows that may be used by the user, but the functionality of the algorithms may be predefined by the predictive analysis application instead of allowing a user to set his or her own values for the intended use. It is challenging and difficult to provide powerful statistical tools that are also user friendly.

### SUMMARY

One embodiment of the present disclosure relates to a custom data manipulation tool that may be created and stored to allow a user to perform one or more statistical analysis steps with reduced configuration. A statistical analysis process chain is exported as a data manipulation tool that allows a user to later execute the statistical algorithm with minimal inputs. Rather than setting up a new statistical analysis process chain every time a user wishes to perform statistical analysis on a set of data, the user may use the previously configured and stored data manipulation tool to perform the statistical analysis.

One embodiment of the present disclosure relates to a computerized method for use with a predictive analysis application. The method includes using processing electronics to cause an electronic display to generate a user interface having controls for allowing a user to configure a predictive analysis chain. The predictive analysis chain includes a complete set of parameters for configuration. The method includes, on the user interface, providing a user selectable option for converting the predictive analysis chain to a data manipulation tool. The method further includes using the processing electronics to convert the predictive analysis chain to the data manipulation tool, wherein the processing electronics store a subset of the complete set of parameters for configuration as requiring future user feedback. The method also includes using the processing electronics to store the converted predictive analysis tool is memory for later selection and use in the predictive analysis application.

Another embodiment of the present disclosure relates to a system including a processor and a non-transitory computer-readable storage device storing instructions that, when executed by the processing module, cause the processing module to perform operations. The operations include generating a graphical user interface having controls for allowing a user to configure a predictive analysis chain. The predictive analysis chain includes a complete set of parameters for configuration. The operations further include, on the graphical user interface, providing a user selectable option for converting the predictive analysis chain to a data manipulation tool. The operations further include converting the predictive analysis chain to the data manipulation tool, wherein the processing module stores a subset of the complete set of parameters for configuration as requiring future user feedback. The operations further include storing the converted predictive analysis tool in memory for later selection and use in the predictive analysis application.

Another embodiment of the present disclosure relates to a non-transitory computer-readable storage device storing instructions that, when executed by a processor, cause the processor to perform instructions. The instructions include generating a graphical user interface having controls for allowing a user to configure a predictive analysis chain, the predictive analysis chain including a complete set of parameters for configuration. The instructions further include on the graphical user interface, providing a user selectable option for converting the predictive analysis chain to a data manipulation tool. The instructions further include converting the predictive analysis chain to the data manipulation tool, wherein the processor stores a subset of the complete set of parameters for configuration as requiring future user feedback. The instructions further include storing the converted predictive analysis tool in memory for later selection and use in the predictive analysis application.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system including a predictive analysis system, according to an exemplary embodiment;

FIG. 2A is a detailed block diagram of a tool creation module of the predictive analysis system that is configured to generate a new tool usable for manipulating data, according to an exemplary embodiment;

FIG. 2B is a detailed block diagram of a data manipulation tool database of the predictive analysis system that is configured to store executed algorithm data, according to an exemplary embodiment;

FIG. 3 is a flow chart of a process for executing a statistical analysis and converting the statistical analysis into a data manipulation tool, according to an exemplary embodiment;

FIGS. 4-9 are example user interfaces of a predictive analysis system illustrating a process of executing a statistical analysis, according to an exemplary embodiment;

FIGS. 10-12 are example user interfaces of a predictive analysis system illustrating a data manipulation process, according to an exemplary embodiment;

FIGS. 13-16 are example user interfaces of a predictive analysis system illustrating a process of creating a new data manipulation tool for statistical analysis, according to an exemplary embodiment;

FIG. 17 is a flow chart of a process for creating a new data manipulation tool, according to an exemplary embodiment; and

FIG. 18 is a flow chart of a process for using a data manipulation tool for statistical analysis, according to an exemplary embodiment.

### DETAILED DESCRIPTION

Referring generally to the figures, systems and methods for generating a data manipulation tool on a user interface usable for performing a statistical analysis is shown and described. The tool may be provided in a predictive analysis application configured to apply one or more statistical algorithms to a group of data.

The predictive analysis application or tool includes manipulation tools that a user may select to change data to be analyzed by the predictive analysis tool. The manipulation tools may allow the user to change data from one value to another, format the data, duplicate the data, change a column or row label, or otherwise transform the data. For example, the manipulation tools may include a find-replace function that finds a string of text in the data and replaces the text with another string, a rename function that renames a column or row, a duplication function that duplicates or copies a row or column of data, a convert function that converts numbers into another format, or otherwise transforms the data.

A custom manipulation tool may be created that allows a user to perform one or more statistical analysis steps with reduced configuration. The user may choose to convert an already existing statistical analysis process chain. The statistical analysis process chain may be a group of processing components linked together that represents a statistical algorithm. The statistical analysis process chain is exported as a data manipulation tool that allows a user to later execute the statistical algorithm with minimal inputs. Therefore, instead of setting up a new statistical analysis process chain every time a user wishes to perform statistical analysis on a set of data, the user may use the previously configured and stored data manipulation tool to perform the statistical analysis.

In one embodiment, the data manipulation tool may be created by a first user (e.g., a statistical expert) for one or more second users (or for the first user's own use). A first user may execute an algorithm using the predictive analysis application and then create a manipulation tool based on the executed algorithm. The manipulation tool may be created using values for components that the first user used. The one or more second users may then execute the algorithm in the future via the manipulation tool without being presented the additional options that the first user previously chose.

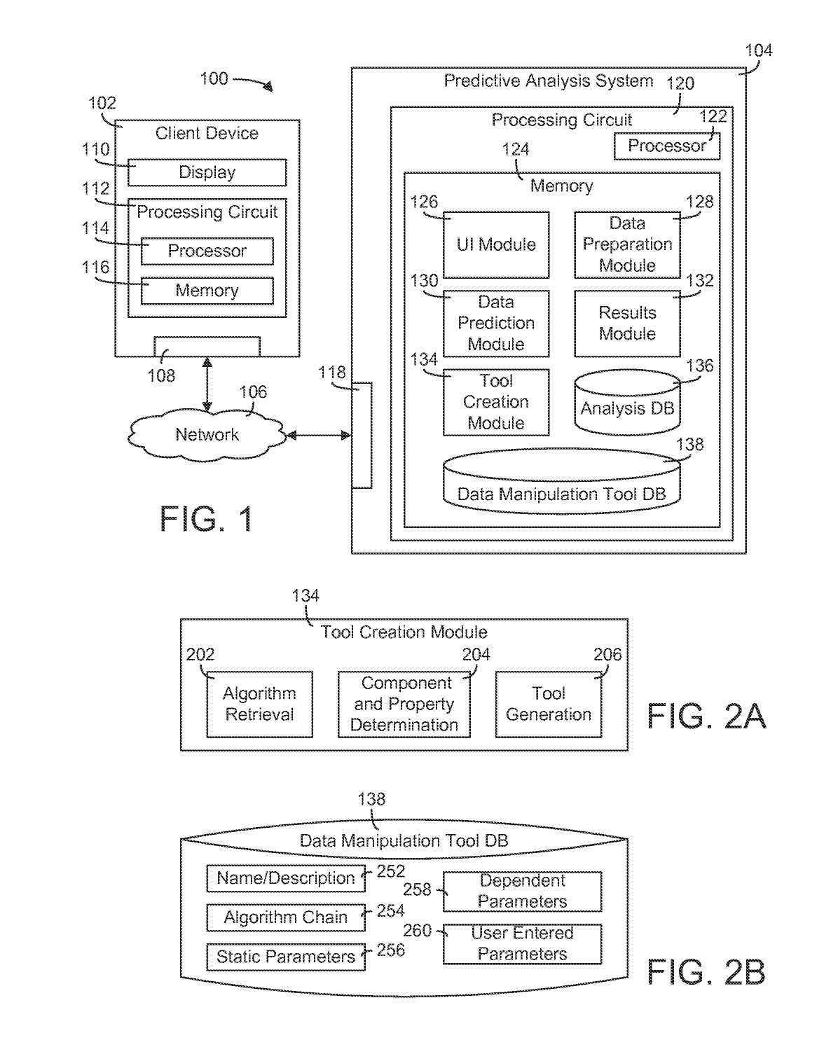

Referring to FIG. 1, a block diagram of a computer system 100 including a predictive analysis system 104 is shown, according to an exemplary embodiment. Predictive analysis system 104 may be configured to perform statistical analysis on a group of data for a user (e.g., a user at client device 102). The statistical analysis may be, for example, a projection of future data values, a determination of one or more patterns in the data, or another type of predictive statistical analysis. Predictive analysis system 104 may receive input from one or more client devices 102 for configuring a statistical analysis project, one or more sets of data to analyze, or other information. Predictive analysis system 104 and the one or more client devices 102 may communicate with one another via a network 106.

Client device 102 may be any type of electronic device (e.g., desktop computer, laptop, tablet, smartphone, etc.) configured to communicate via network 106 via an interface 108. Interface 108 may be any type of communications interface configured to communicate with predictive analysis system 104 via network 106 either wirelessly or via a wired connection. Similarly, predictive analysis system 104 includes an interface 118 for communicating with client device 102 via network 106 wirelessly or via a wired connection. Network 106 may include the Internet and/or other types of data networks, such as a local area network (LAN), a wide area network (WAN), a cellular network, satellite network, or any other type of network. Client device 102 includes a display 110 configured to display a user interface generated by predictive analysis system 104 and a processing circuit 112 including a processor 114 and memory 116. Although FIG. 1 is illustrated as having a client/server topology, it should be appreciated that the predictive analysis system may be implemented as having a ‘thick’ software application, an entirely local application, and/or an application where the processing components are all stored locally, but the data is stored on a remote data store.

Predictive analysis system 104 is shown to include a processing circuit 120 including a processor 122 and memory 124. Processor 122 may be, or may include, one or more microprocessors, application specific integrated circuits (ASICs), circuits containing one or more processing components, a group of distributed processing components, circuitry for supporting a microprocessor, or other hardware configured for processing. Processor 122 is configured to execute computer code stored in memory 124 to complete and facilitate the activities described herein. Memory 124 can be any volatile or non-volatile computer-readable storage medium capable of storing data or computer code relating to the activities described herein. For example, memory 124 is shown to include modules 126-134 which are computer code modules (e.g., executable code, object code, source code, script code, machine code, etc.) configured for execution by processor 122. According to some embodiments, processing circuit 120 may represent a collection of processing devices (e.g., servers, data centers, etc.). In such cases, processor 122 represents the collective processors of the devices and memory 124 represents the collective storage devices of the devices. When executed by processor 122, processing circuit 120 is configured to complete the activities described herein as associated with the predictive analysis system 104. In an exemplary embodiment, predictive analysis system 104 may be the primary predictive analysis engine or device while client device 102 merely presents ‘thin’ user interfaces for interacting with the predictive analysis system 104. It should be appreciated that other topologies may be encompassed by the claims, unless specifically limited.

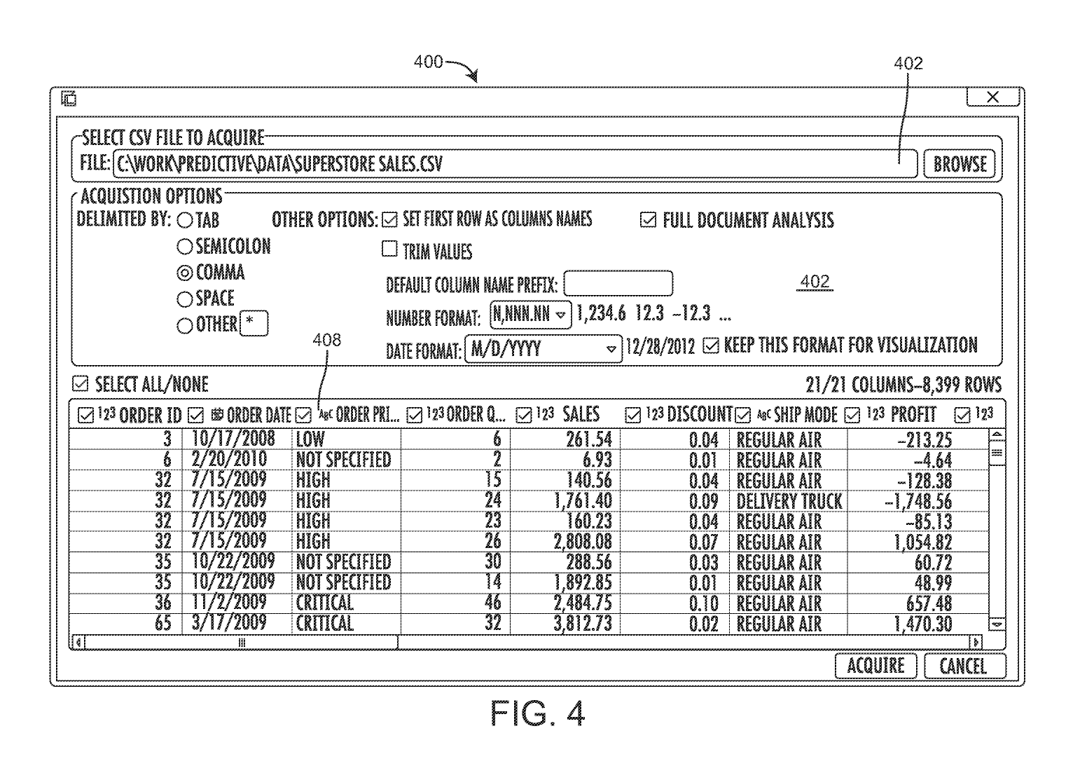

Memory 124 is shown to include a user interface (UI) module 126. UI module 126 is generally configured to generate a user interface for client device 102. For example, UI module 126 may generate the user interfaces as illustrated in FIGS. 4-16. Depending on the system topology, UI module 126 may provide data for rendering the graphical user interface (in which the client device 102) conducts the rendering and final display steps or UI module 126 may provide rendered graphics output to a display or remote system directly. In either instance, UI module 126 may be said to generate the user interface for display or to cause the user interface to be displayed.

Memory 124 is shown to include a data preparation module 128. Data preparation module 128 is generally configured to retrieve data for use in statistical analysis and to modify the data based on user input and/or algorithm settings. In one embodiment, predictive analysis system 104 may receive one or more data files from various sources (e.g., from client device 102 or from another source via network 106) or data from one or more databases either local or remote to system 104. For example, referring also to FIG. 4, the user may select one or more data files to send to predictive analysis system 104. Data preparation module 128 may receive the one or more data files and may be configured to load the data for processing. For example, in the user interface of FIG. 4, various options are shown that allow the user to specify how to process the incoming data.

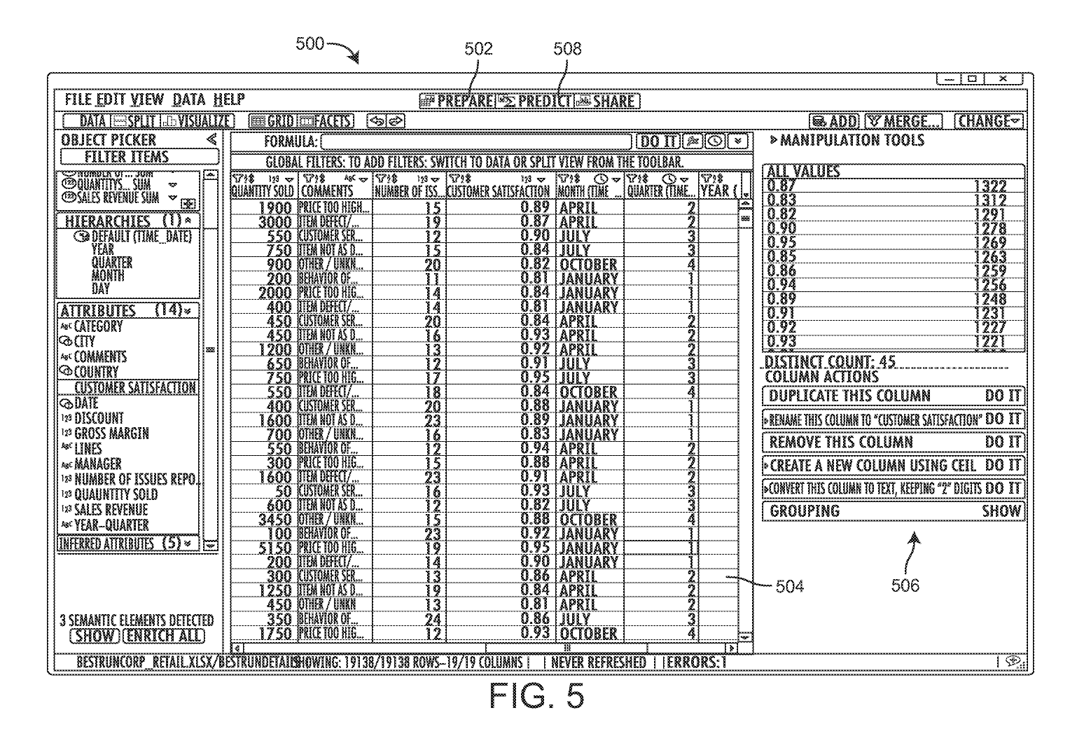

Data preparation module 128 may further prepare the data for processing. For example, data preparation module 128 may filter data, group like data together, or perform any other pre-processing task to prepare the data for statistical analysis. The data processing may be part of a pre-processing routine of predictive analysis system 104, or may be based on one or more user inputs at client device 102. For example, UI module 126 may be configured to display the loaded data on a user interface, and data preparation module 128 may receive user inputs from the user interface relating to changes in the data. In the embodiment of FIG. 5, an example user interface is illustrated in which data processed by data preparation module 128 is displayed for the user.

Memory 124 is shown to include a data prediction module 130. Data prediction module 130 is generally configured to execute statistical analysis using the data available, one or more selected algorithms, and components and parameters thereof. Data prediction module 130 may receive a user input relating to one or more selected components or algorithms to execute, in addition to any parameters or other values specified by the user.

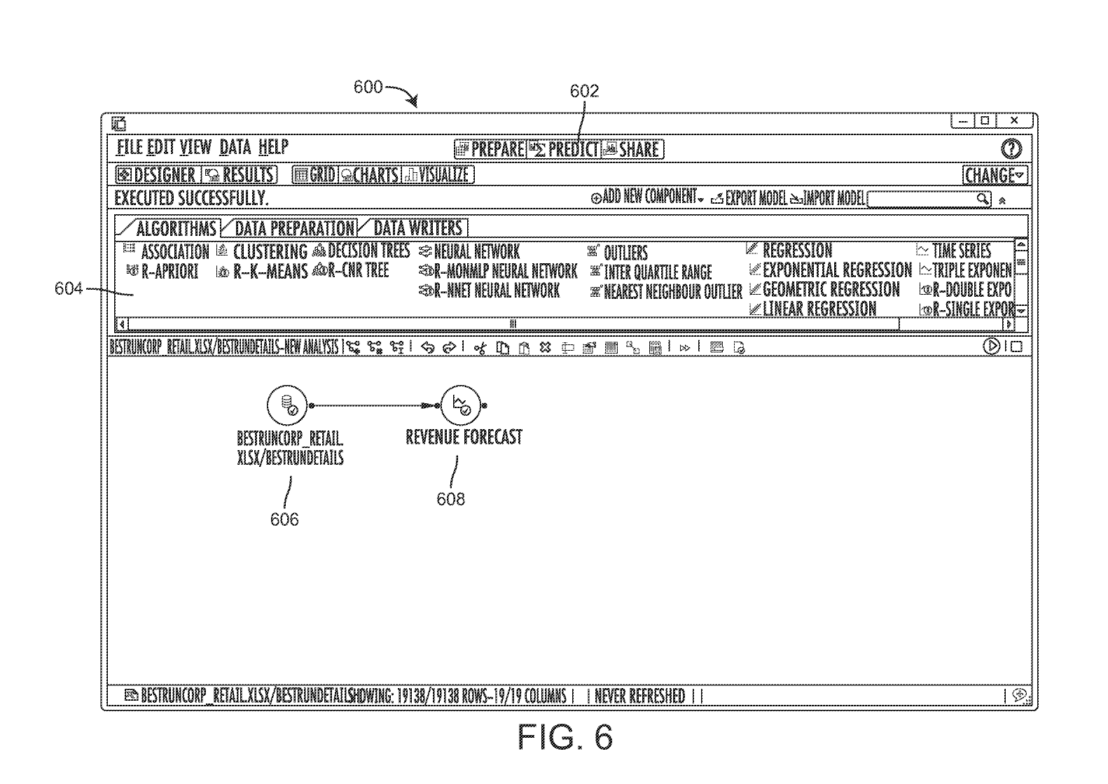

In one embodiment, data prediction module 130 may receive a user input (e.g., via UI module 126) including a selected set of data to analyze. Data prediction module 130 may also receive a user input indicating a selected algorithm to use. For example, referring to FIGS. 5-6, the user may first select a group of data for which the user would like to perform analysis with. The user may select a row of data, a column of data, or any other subset of data in the user interface of FIG. 5. The user may then select the predict tab to reach the user interface of FIG. 6. The user may select one or more algorithms and other options to select a type of analysis to perform on the data. Data prediction module 130 may work in concert with UI module 126 to provide the relevant user interfaces (e.g., the user interfaces of FIGS. 5-6).

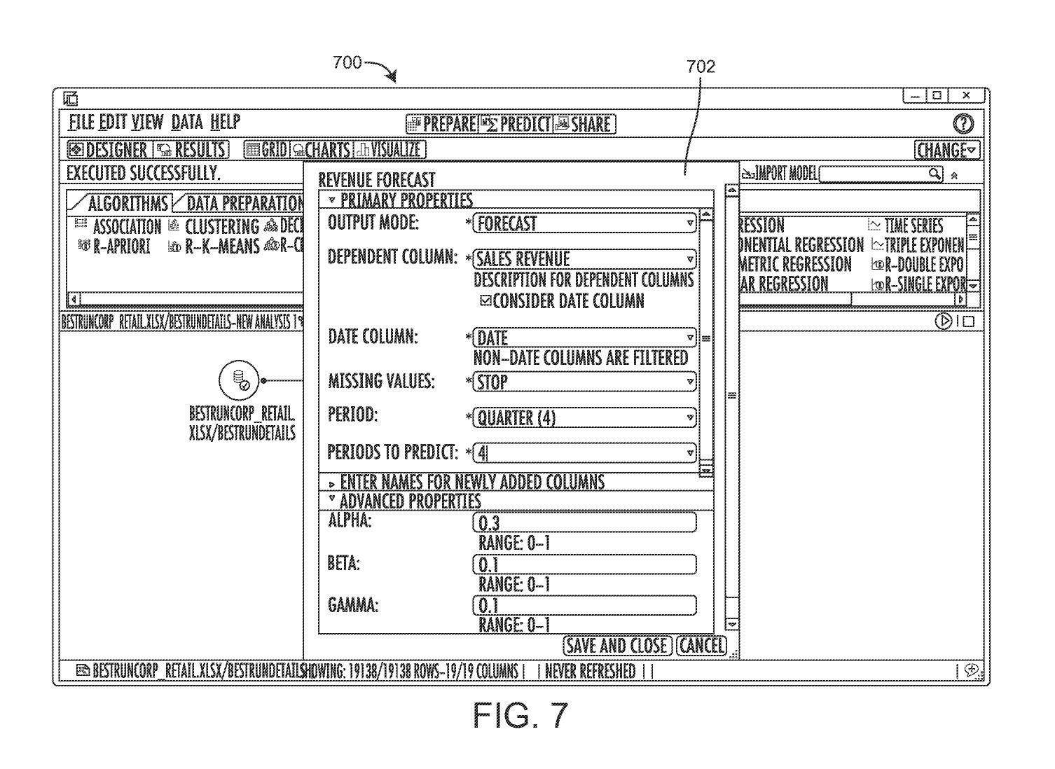

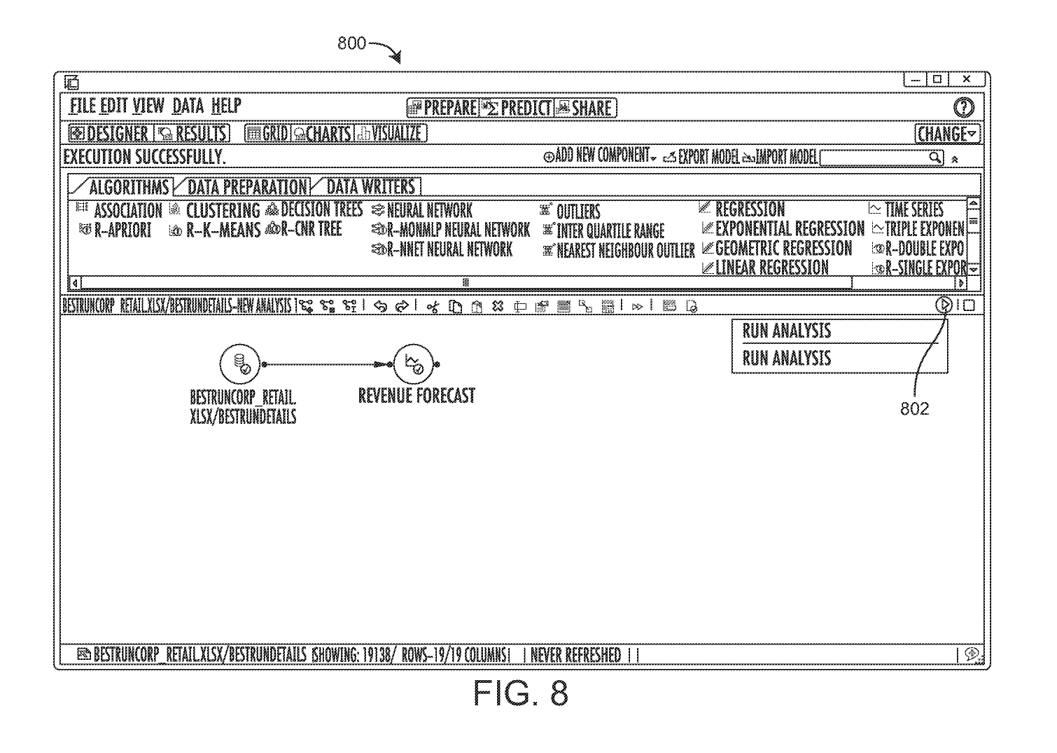

Data prediction module 130 may prompt the user for one or more values of properties or components relating to the algorithm. For example, the user may be presented with a window as shown in FIG. 7 upon requesting a statistical analysis to project future revenues. The user may be prompted to indicate how many time periods to project ahead, how long each time period should be, a title and other presentation-related fields, and algorithm-specific values. After specifying all desired values for the properties, data prediction module 130 may execute the algorithm upon user command. For example, in the user interface of FIG. 8, the user has finished specifying values for the properties and may click the “run analysis” option to execute the algorithm. Data prediction module 130 may then execute the algorithm using the values provided by the user and other algorithm-specific values and techniques.

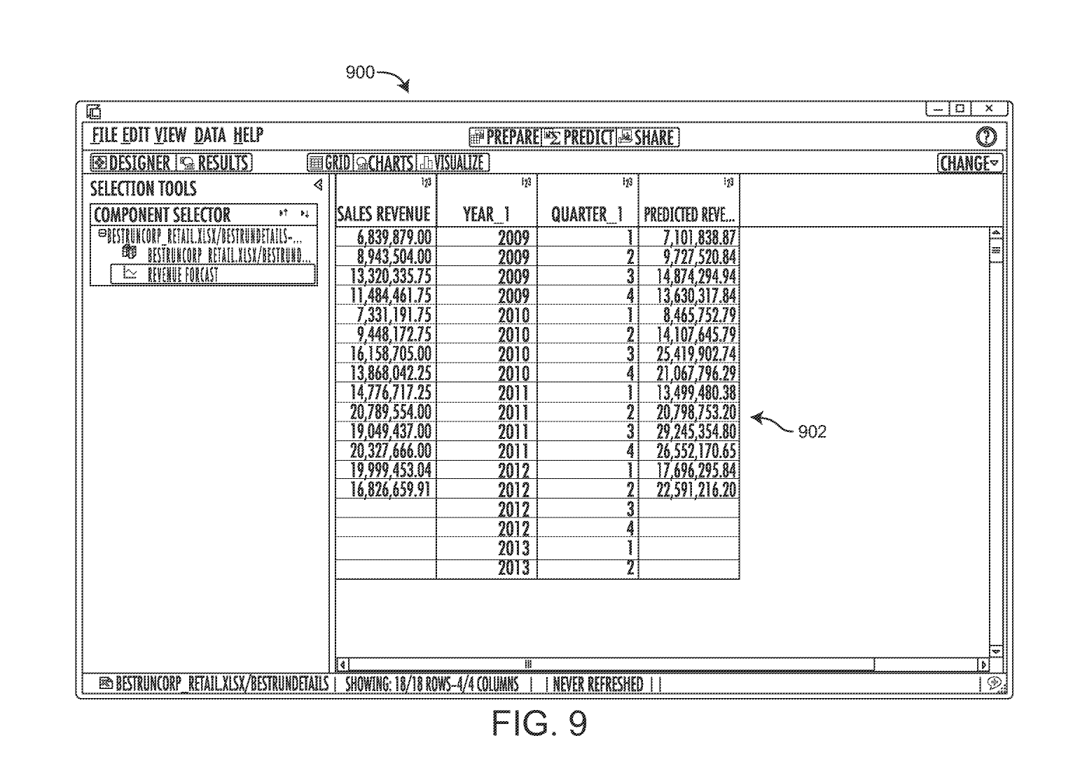

Memory 124 is shown to include a results module 132. Results module 132 is generally configured to take the results of the statistical analysis and to generate a display, report, or other output of the results to a user. In one embodiment, results module 132 may generate a screen as shown in the user interface of FIG. 9. The user interface of FIG. 9 may be formatted similarly to other user interfaces generated by predictive analysis system 104, for example. Using the example described above, the results screen may show the projected revenue along with data used to generate the projected revenue (e.g., the previous sales revenue and a timestamp or other time-related identifier for the previous sales revenue). Results module 132 may further be configured to store the results in an analysis database 136.

Predictive analysis system 104, and tool creation module 134 more particularly, may be configured to store configured algorithm data in data manipulation tool database 138 for later use. For example, for an executed algorithm, the algorithm may generally be represented as a group of components linked together to form a statistical analysis process chain. Each component of the algorithm, along with values for each property specified by the user and/or the algorithm, may be stored in data manipulation tool database 138 for future use. Data manipulation tool database 138 is described in greater detail in FIG. 2B.

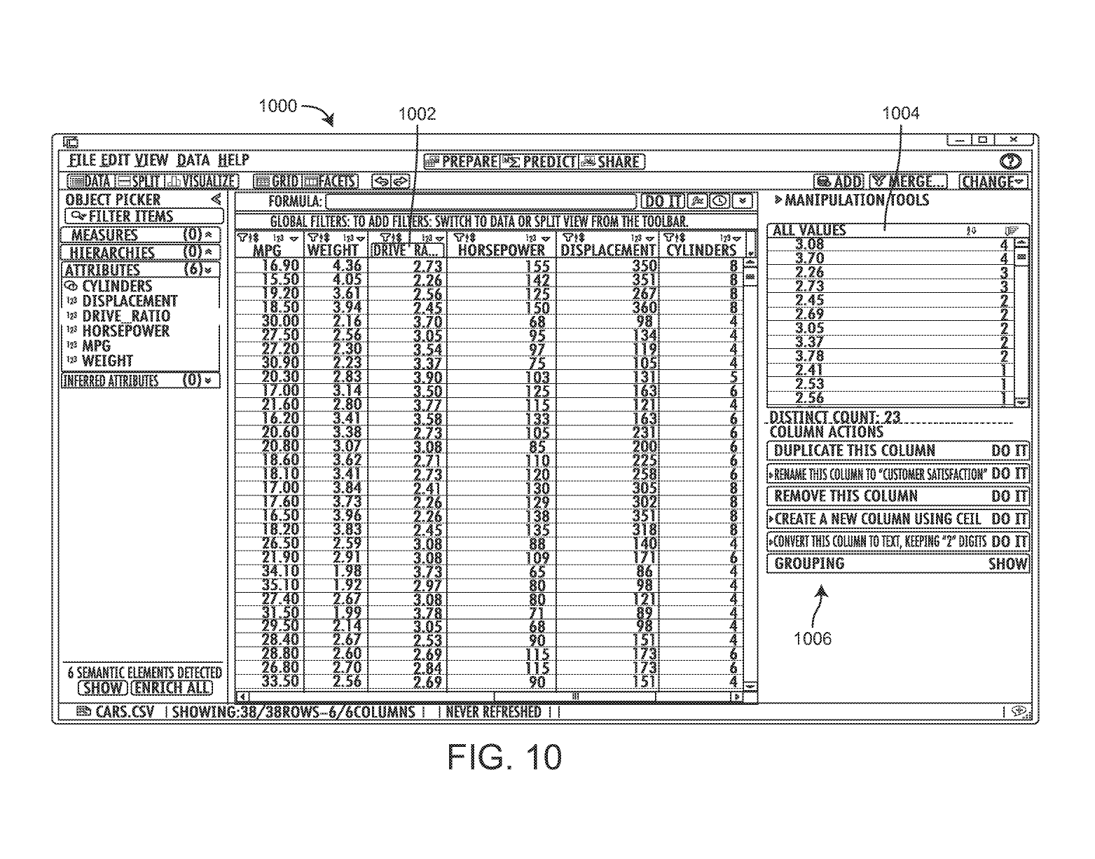

Memory 124 is shown to include a tool creation module 134. Tool creation module 134 is generally configured to create a data manipulation tool for further use by predictive analysis system 104. A data manipulation tool may be provided on a user interface for a user to select for execution by predictive analysis system 104 for insertion into a larger predictive analysis chain. Several example data manipulation tools are shown in the user interface of FIG. 10. A conventional data manipulation tool may be used to duplicate or erase a row or column of data, rename a row or column of data, remove a row or column or other subset of data, create a new row or column of data using values from other data cells, convert the contents of a cell, row, or column from a text format to a number format or vice versa, group selected data together, or otherwise. According to the present application, a predictive analysis chain may be used to generate a new data manipulation tool which conducts one or more semi-preconfigured predictive analysis algorithms.

An example of using a conventional data manipulation tools is illustrated in FIGS. 10-12. The user has selected the data manipulation tool that allows the user to replace one string of text with another string of text in selected data cells. The data manipulation tool may generally be designed as a simple-to-use tool that allows the user to modify data with minimal inputs.

Referring now to FIG. 2A, a block diagram of a tool creation module 134 is shown, according to an exemplary embodiment. Tool creation module 134 is configured to generate a new data manipulation tool for a user interface of predictive analysis system 104. Tool creation module 134 generates a defined data manipulation tool for storage and later retrieval and use. Once created, the generated data manipulation tool may be used as if it were a standard data manipulation tool although it is a predictive analysis chain. The generated data manipulation tool allows a user to easily execute a complex statistical analysis on a set of future data, with minimal input, and by using familiar user interface interactions (e.g., use of a data manipulation tool).

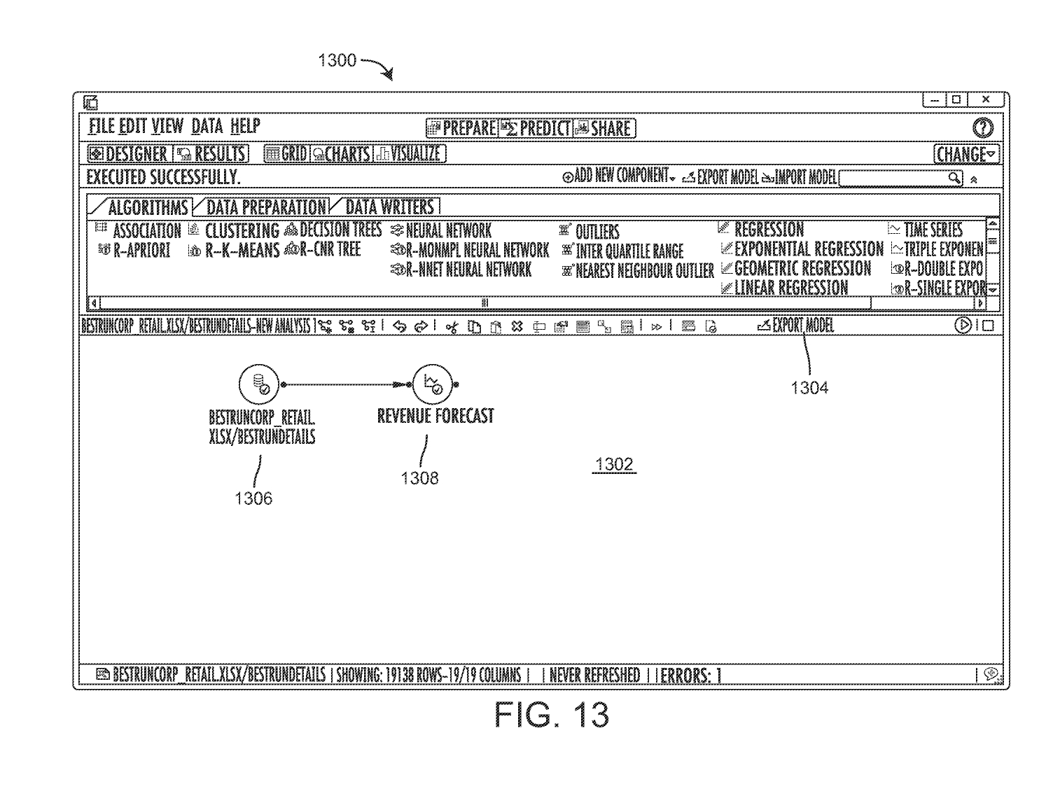

Tool creation module 134 may include an algorithm retrieval process 202. Algorithm retrieval may generally include receiving a user input indicating one or more executed algorithms or components thereof to convert into a data manipulation tool, and retrieving the algorithms and components thereof from data prediction module 130 or analysis database 136. For example, after selecting an algorithm, a user may choose to “export” the algorithm into a data manipulation tool for use in the future, as shown by the export option in the user interface of FIG. 13. The user may select the algorithm for converting into a data manipulation tool with or without first executing the algorithm on a set of data.

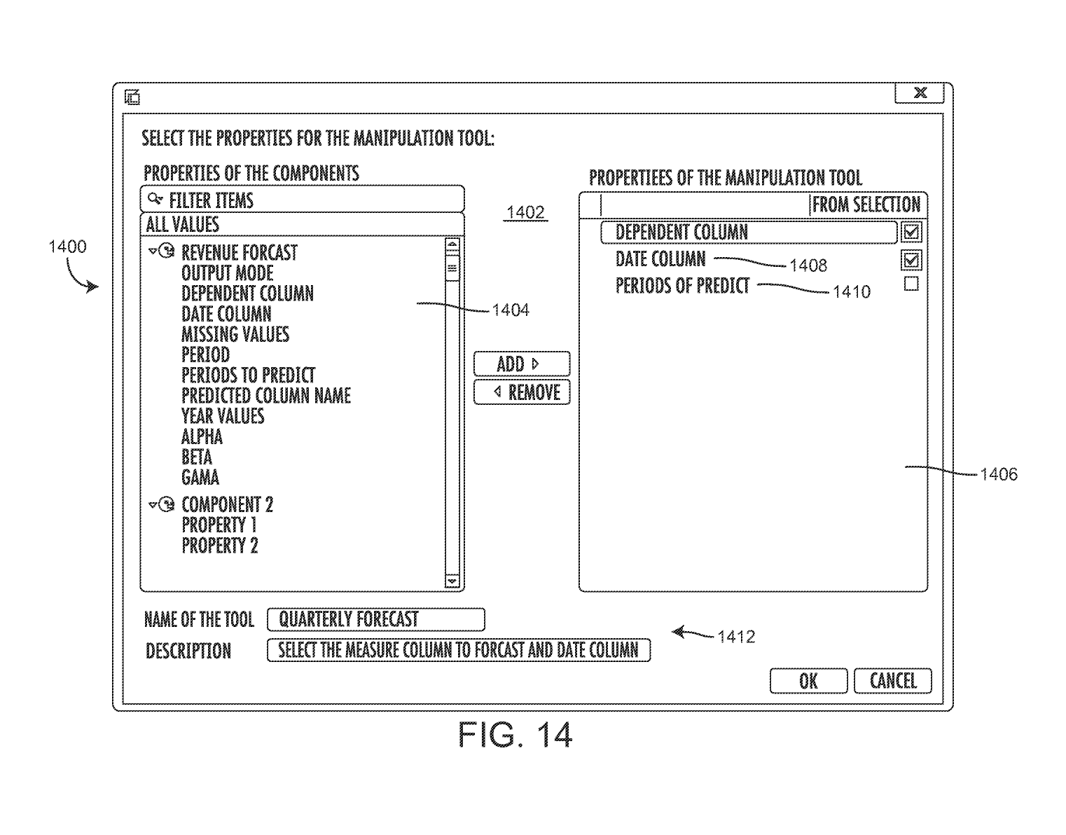

Tool creation module 134 may include a component and property determination process 204. After retrieval of the executed algorithm and all components and properties thereof, tool creation module 134 may determine which components are essential to the execution of the algorithm, which properties require a user input, and which properties do not require a user input. Referring also to FIG. 14, tool creation module 134 may present the user with a window on the user interface listing all configurable algorithm components. Tool creation module 134 may identify properties of components that must be included as part of the data manipulation tool (e.g., properties which require a user input) and list the components and properties in the window. For example, for a revenue projection, tool creation module 134 may determine that date information and a period of time to project revenue for may be required properties, shown in the right portion of the user interface of FIG. 14. All possible properties that may be used in the revenue projection may be listed in the left portion of the user interface of FIG. 14. The user may select additional properties in the list in order to make the properties “required” by the data manipulation tool (e.g., properties which require a user input or other interaction of some kind before execution of the algorithm).

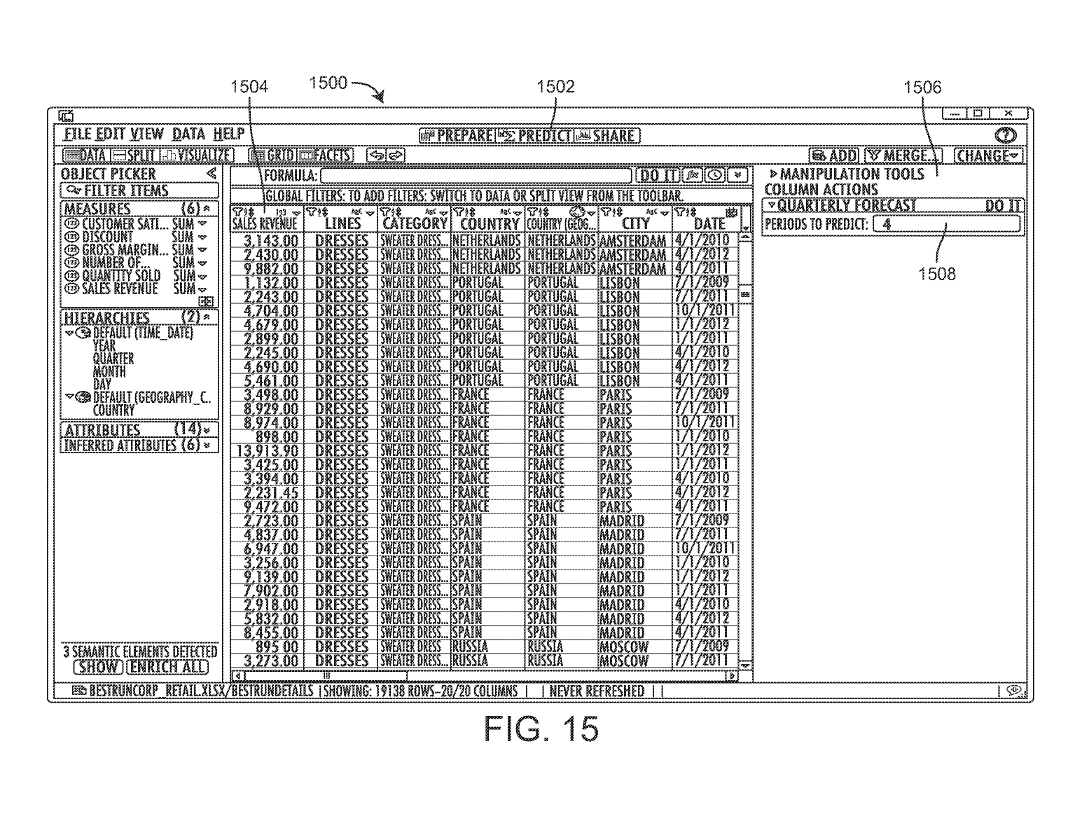

The user may indicate to tool creation module 134 whether or how to prompt the user to enter values for the properties. Referring to FIG. 14, the user may determine properties which need to be provided in the input data (e.g., the “date column” property may be provided by a user selection of data) and properties which need to be manually user-entered (e.g., the “periods of predict” property may be provided by a user entered value). The sample data manipulation tool is shown in FIG. 15 for projecting revenue. The user may select a column of data (e.g., “sales revenue”) to use in the projection to satisfy the “date column” property and enter a value that specifies how many time periods to project revenue for (e.g., 4, as shown in FIG. 15).

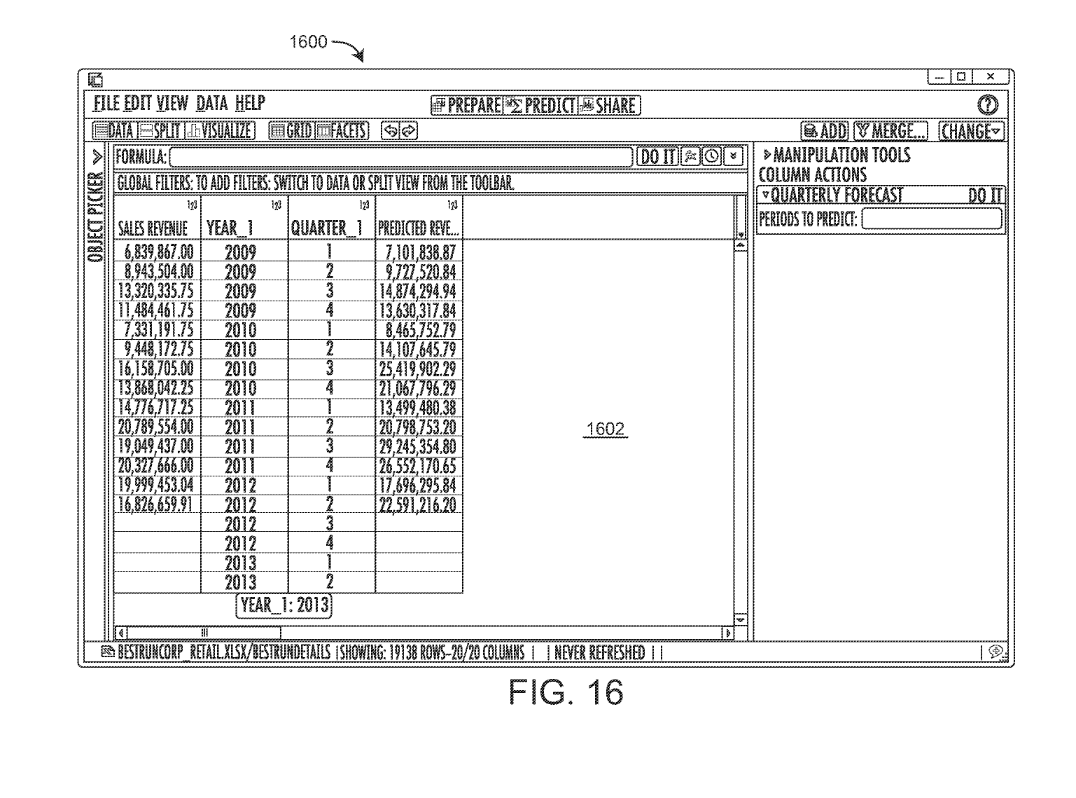

Tool creation module 134 may include a tool generation process 206. After receiving the user selection of properties, along with additional information such as a name and description of the data manipulation tool, tool creation module 134 may generate the data manipulation tool in memory. The data manipulation tool may then be displayed as an option on a user interface along with the other data manipulation tools when the user interface is generated. For example, tool creation module 134 may generate and store the data manipulation tool, for display as illustrated in FIG. 15, with one field for allowing the user to enter a number of periods of time to project for. The user may then use the data manipulation tool by entering in a value and selecting data in order to generate a report as shown in FIG. 16.

Referring to FIG. 2B, data manipulation tool database 138 is shown in greater detail. Data manipulation tool database 138 may generally store information relating to executed algorithms. When a user creates a data manipulation tool based on an executed algorithm via tool creation module 134, data about the executed algorithm may be stored in data manipulation tool database 138.

The data may include name/description information 252. A name and/or description of the data manipulation tool may be provided by the user or generated by tool creation module 134. For example, the user may name the data manipulation tool and provide a description that allows a second user to identify how the data manipulation tool is used.

The data may include algorithm chain information 254. As mentioned above, the algorithm may be represented by data prediction module 130 as a linked group of components. Information about the execution of each component of the algorithm may be stored as algorithm chain information 254.

The data may include static parameter information 256. Static parameters may be parameters or values for one or more components or sub-components that are fixed. The values may be identified by a user, during the tool creation process, as values that should not be changed by another user.

The data may include dependent parameter information 258. Dependent parameters may be parameters of the components for which a user selection is required. For example, a dependent parameter may be previous sales revenue if the algorithm relates to projecting future revenue.

The data may include user entered parameters 260. User entered parameters may be parameters of the components for which a user entered value is required. For example, a user entered parameter may be a future time period for project revenue for if the algorithm relates to projecting future revenue.

The data stored in database 138 may be used when a user wishes to use or execute the corresponding data manipulation tool. For example, referring also to FIG. 15, the user may select the data manipulation tool “quarterly forecast” on the user interface. Upon selection, data may be retrieved from database 138 that identifies the options to present to the user. A field is generated for the user entered parameter “periods to predict.” The data manipulation tool may also require a user selection of data for the dependent parameters. The static parameters are hidden from the user, since no user interaction with the static parameters are required. In an exemplary embodiment, the stored data manipulation tool may itself be added to a new predictive analysis chain.

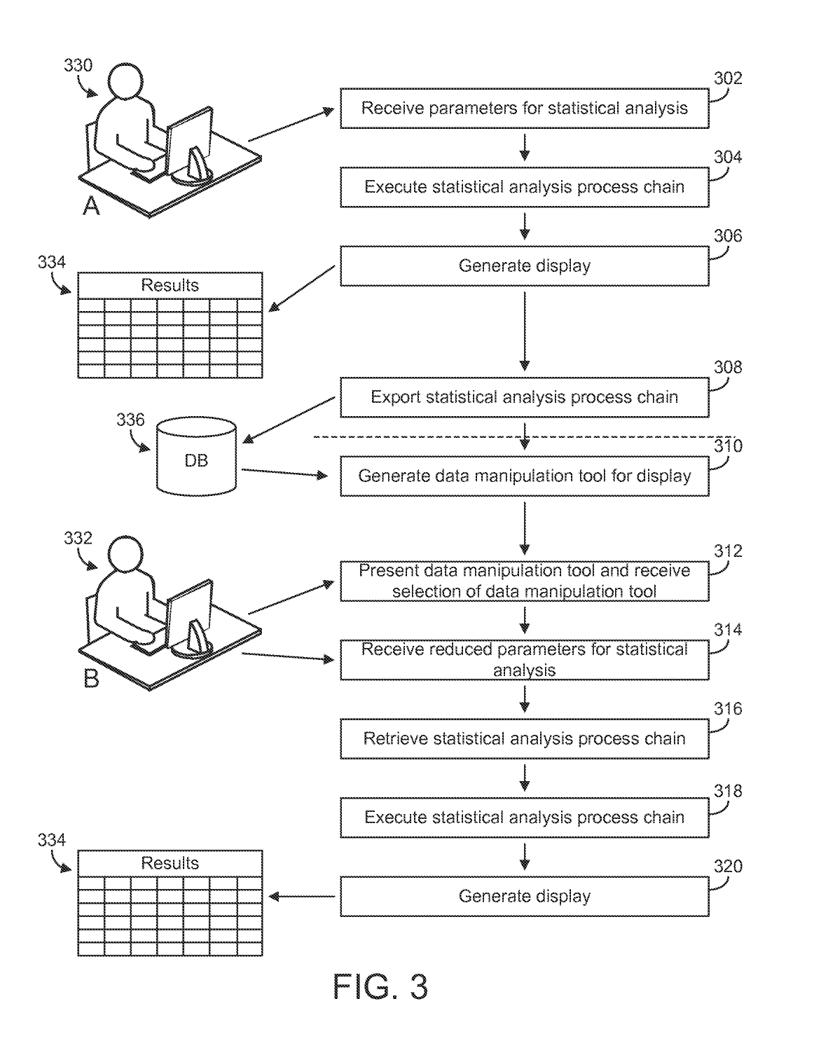

Referring to FIG. 3, a flow chart of a process 300 for executing a statistical analysis and converting the statistical analysis into a data manipulation tool is shown. Process 300 may be executed by, for example, predictive analysis system 104, receiving input from one or more users 330, 332 and interacting with a display 334 and database 336.

Process 300 includes receiving parameters for statistical analysis from a first user 330 (step 302). For example, a user may wish to perform a statistical analysis on a group of data. Step 302 may include user 330 providing an indication to initiate the statistical analysis process. User 330 may select data via the user interface to analyze. User 330 may then select values for one or more parameters of the algorithm to execute via the user interface. Process 300 then includes executing the statistical analysis process chain to execute the algorithm (step 304). The statistical analysis process chain may include one or more components with a defined set of properties (e.g., a combination of pre-set values and parameter values received from the user) representative of the algorithm.

Process 300 further includes generating a display 334 on a user interface displaying the results of the algorithm (step 306). Process 300 further includes exporting the statistical analysis process chain to a database 336, such as analysis database 136 (step 308). Each component, with a defined set of properties and values thereof, may be stored in database 336.

Process 300 further includes generating a data manipulation tool for display on the user interface (step 310). The data manipulation tool may be based on the executed algorithm. The request for generating the data manipulation tool may be received from user 330 (e.g., the user to provided the initial request to execute the algorithm). The data manipulation tool may be generated so that another user (e.g., second user 332) may execute the algorithm with less input than first user 330 provided.

Step 310 may include presenting user 330 with a dialog box where all properties of the components are listed for user 330. User 330 may select properties for which a second user 332 should be prompted for values for when executing the data manipulation tool. Additionally, one or more properties may be pre-selected as properties which require user 332 input. However, most properties may have static or fixed values which do not require user 332 input, and step 310 may include listing such properties in a separate window to indicate they are optional. The data manipulation tool may be generated, and may be available to any other user until a user manually removes the tool.

The data manipulation tool may be presented to another user 332 during future use of the predictive analysis application, and a user selection of the data manipulation may be received (step 312). In one embodiment, user 330 may create the data manipulation tool at one time and second user 332 may access the data manipulation tool at a later time. The selection of the data manipulation tool may include clicking on the data manipulation tool on the user interface, activating one or more fields for entering data. User 332 may enter parameters for statistical analysis via the one or more data fields (step 314). For example, the data manipulation tool may be presented to user 332 on the user interface as two fields with short descriptions. User 332 may enter his or her desired values and submit the values to the predictive analysis system. User 332 may further provide a selection of data to perform statistical analysis on using the data manipulation tool.

Process 300 further includes retrieving the statistical analysis process chain from database 336 related to the data manipulation tool (step 316). The statistical analysis process chain may then be executed using the new values for properties provided by second user 332 (step 318), thereby executing the statistical algorithm for user 332. A display of the results may be generated for the user (step 320).

Referring generally to FIGS. 4-16, various example user interfaces that may be generated by predictive analysis system 104 are illustrated. Referring more specifically to FIGS. 4-9, example user interfaces that illustrate a process of performing a statistical analysis on a group of data is shown.

Referring to FIG. 4, an example user interface 400 is illustrated for allowing a user to provide one or more data files to predictive analysis system 104. User interface 400 includes a field 402 for allowing the user to select a file. The file may be local to the user and, for example, client device 102. In another embodiment, the user may select a file not located on client device 102 (e.g., a file accessible via the Internet, a file stored remotely from client device 104, etc.). The file may be any type of database file, a spreadsheet (e.g., an Excel file, .csv file, etc.) or any other type of file with data. User interface 400 further includes an option box 404 that presents the user with various options for how to load the data in the file (e.g., setting column or row names for the data, the text, date, or number format to apply to the data, how the data is delimited in the file, etc.). User interface 400 further includes a data box 406 that displays the data, previews the formatting of the data, and otherwise. The user may select acquire button 408 to initiate the loading of the data to predictive analysis system 104.

Referring to FIG. 5, user interface 500 may be presented to the user which displays the uploaded data. User interface 500 illustrates a data preparation screen 502. In data preparation screen 502, the user may prepare data 504 for statistical analysis. Data preparation screen 502 is shown to include one or more data manipulation tools 506 (described in greater detail in FIGS. 10-12) that allow the user to prepare data 504.

When the user is ready to perform statistical analysis on data 504 or a portion thereof, the user may select button 508 to be taken to a data prediction screen 602 as shown in user interface 600 of FIG. 6. In data prediction screen 602, the user may be presented with a list of available algorithms 604 or other techniques for analyzing the data. In the embodiment of FIG. 6, the user has selected a subset of data 606 for generating a revenue forecast 608.

After the user has selected one or more algorithms, the user may be presented with a properties window 702 as shown in user interface 700 of FIG. 7. Properties window 702 may allow a user to enter values for one or more properties associated with the algorithm, along with other formatting preferences. After the user is finished entering values, the user may run the analysis via button 802 as shown in user interface 800 of FIG. 8. After analysis, the user is provided with a results window 902 as shown in user interface 900 of FIG. 9.

Referring now to FIGS. 10-12, example user interfaces that illustrate the process of data manipulation in greater detail is shown. Referring to FIG. 10, user interface 1000 is shown in which the user has selected a column of data 1002. User interface 1000 includes a data manipulation window 1004. Window 1004 displays the selected data 1002 in window 1006.

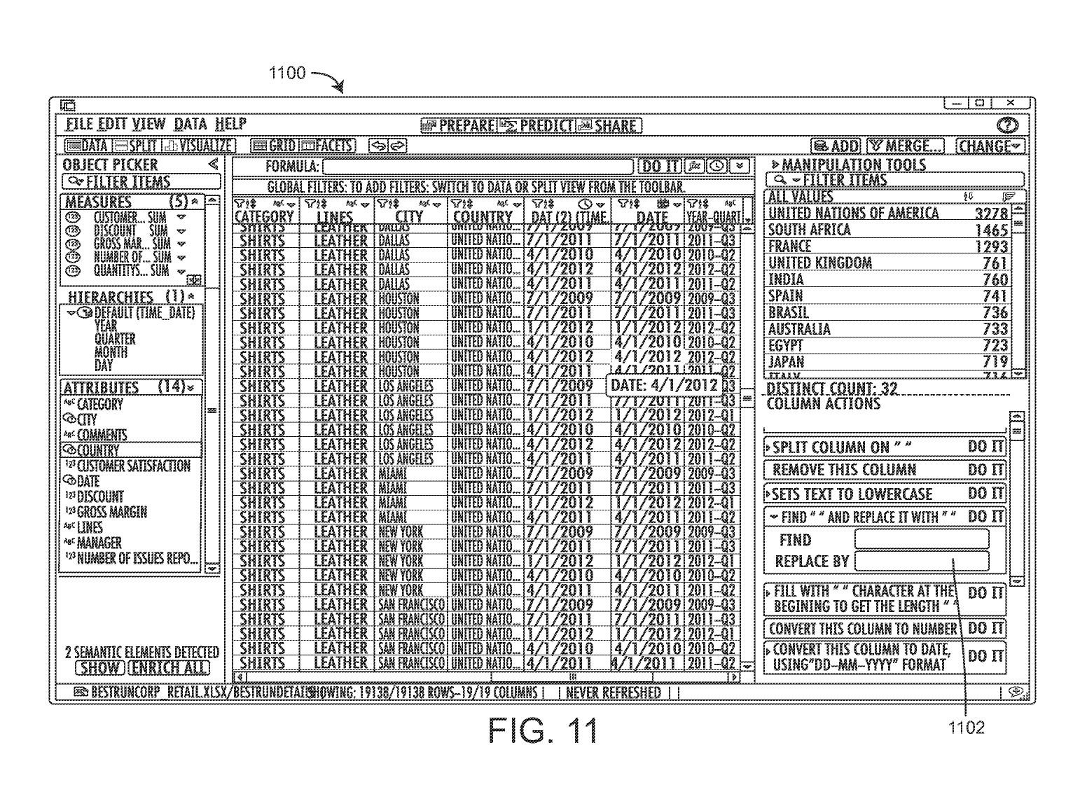

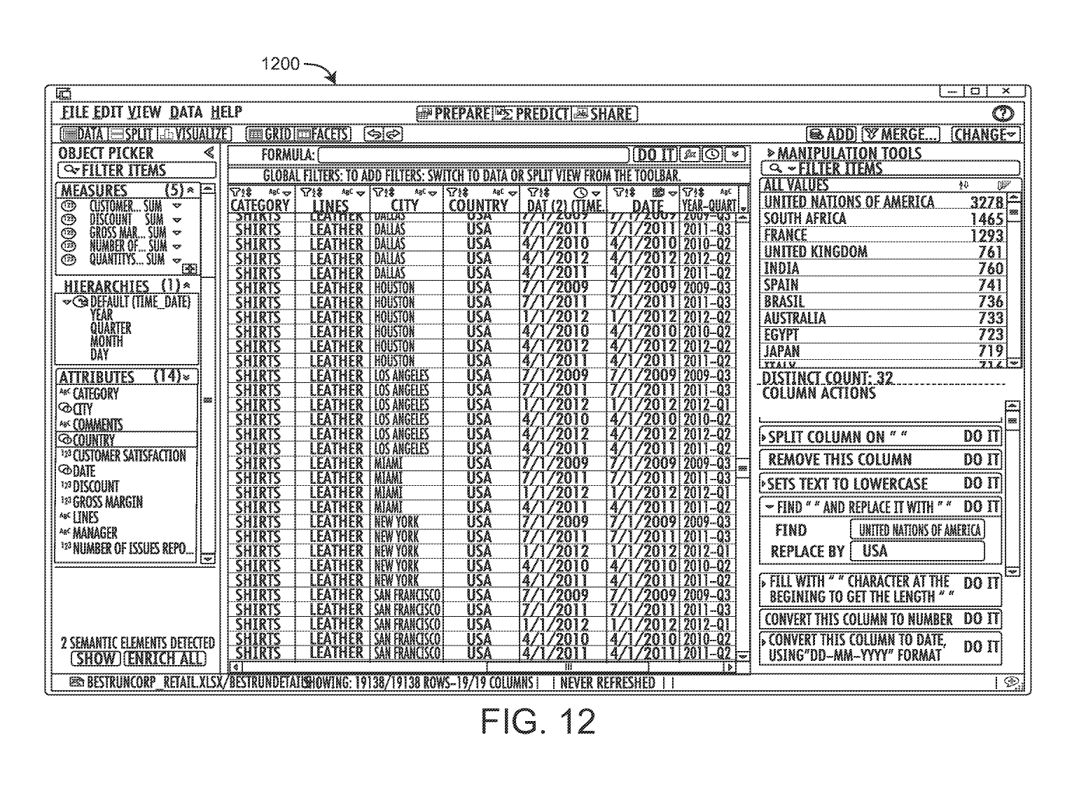

Data manipulation window 1004 includes multiple action boxes 1008 that a user may interact with to manipulate the data (e.g., for duplicating the selected row, column, or data, for renaming the column header, for converting text to numbers and vice versa, for creating or removing columns or rows, for grouping data together, etc.). In user interface 1100 of FIG. 11, the user has selected a find-replace box 1102 in which the user may search for strings of text in the selected data to find and replace with another string of text. In user interface 1200 of FIG. 12, the user has replaced the string “United Nations of America” with the string “USA.”

Referring now to FIGS. 13-16, example user interfaces that illustrate the process of creating a new data manipulation tool for the execution of a statistical analysis is shown. Referring to FIG. 13, a user interface 1300 is shown that is similar to user interface 600 of FIG. 6 for selecting an algorithm and executing a statistical analysis. User interface 1300 is shown to include a data prediction screen 1302 in which an algorithm has just been executed for statistical analysis. Data prediction screen 1302 includes a export button 1304. Upon selecting export button 1304, the user may be able to generate a data manipulation tool based on the executed algorithm.

Upon selecting export button 1304, the user may be provided a properties window 1402 as shown in user interface 1400 of FIG. 14. The predictive analysis system may generate a list of all properties of components in the algorithm in window 1404. For example, if the algorithm relates to a future revenue projection, window 1404 may list all relevant properties for executing the algorithm Relevant properties may include one or more columns, rows, or sets of data to be selected by the user for analysis, a time period to project revenue for, what to do with missing values in the data set, how long a time period should be, values for identifying a time period (e.g., quarter 1, quarter 2, etc.), and values relating directly to the algorithm (e.g., an alpha, beta, and gamma value).

User interface 1400 further includes a selected properties window 1406 in which required properties for the data manipulation tool are listed. For example, if the algorithm is configured to project revenue, it may be determined that the data manipulation tool for projecting revenue must include an input for previous revenue and an input that indicates how many time periods to project revenue for. Therefore, window 1406 is shown to include a “date column” field 1408. The user may select a column of data of previous revenue for use by the data manipulation tool. Referring also to user interface 1500 and data preparation screen 1502 of FIG. 15, the user has selected the “sales revenue” column 1504 accordingly. The user may indicate (e.g., via the checkmark as shown in FIG. 14) that the field may be satisfied by a user using the data manipulation tool by selecting data in screen 502. Window 1406 further includes a “periods to predict” field 1410. This may cause the data manipulation tool to prompt the user for a manual entry for how many time periods to project revenue for. The un-checked box may indicate to the data manipulation tool that the value must be manually entered by the user, rather than merely determined by a data selection. Window 1402 may further include any other fields 1412 that allow the user to provide a name or description for the data manipulation tool.

Referring again to user interface 1500 of FIG. 15, data manipulation tool 1506 is shown generated by the predictive analysis system. Data manipulation tool 1506 includes a “periods to predict” field 1508 for manual user input. The user is shown to select a column 1504 of data to use in the revenue projection. The user may then execute the revenue projection algorithm to obtain a results screen 1602 as shown in user interface 1600 of FIG. 16.

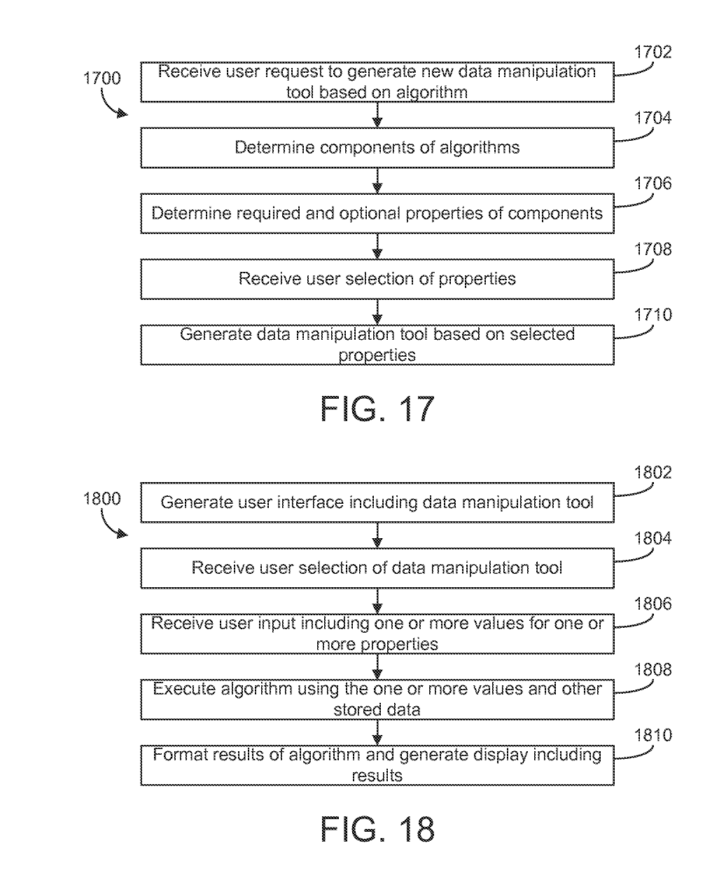

Referring to FIG. 17, a flow chart of a process 1700 for creating a new data manipulation tool is shown, according to an exemplary embodiment. Process 1700 may be executed by, for example, predictive analysis system 104 and more particularly tool creation module 134. Process 1700 may be executed for a first user (e.g., user 330 as shown in FIG. 3) responsible for creating a data manipulation tool for future use.

Process 1700 includes receiving a user request to generate a new data manipulation tool based on an algorithm (step 1702). The algorithm may be an algorithm executed by the user and the predictive analysis system for statistical analysis. The data manipulation tool may be used by a second user different from the user requesting the new tool. The data manipulation tool may allow the second user to execute the algorithm with minimal input or expertise.

Upon receiving the request, process 1700 includes determining components of the algorithm (step 1704) and required and optional properties of the components (step 1706). For example, step 1704 may include generating a list of properties as shown in user interface 1400 of FIG. 14. Step 1706 includes determining which properties require a user input (whether via the selection of data or via a user input of one or more values) and which properties do not require a user input (e.g., properties whose values may be pre-set by the predictive analysis system since the values are usually static or fixed). Step 1706 includes listing the required properties as shown in window 1406 and optional properties in window 1402.

Process 1700 further includes receiving a user selection of properties (step 1708). The user selection of properties may include which properties the user wishes to prompt a user for when using the data manipulation tool. For example, the user may add additional required properties in addition to the required properties determined by the predictive analysis system. Referring also to FIG. 14, step 1708 may include selecting a property in window 1402 to list as a required property in window 1406. Step 1708 may further include receiving an indication from the user on how another user should enter values or data for the properties (e.g., whether the user can select data to use for the tool, whether the user has to manually enter values for the tool, etc.). For example, in FIG. 14, a checkbox is provided for each property that allows the user to specify if the value should be entered manually by another user or can be achieved with the selection of a set of data. Process 1700 further includes generating the data manipulation tool based on the selected properties (step 1710). For example, referring again to FIG. 15, data manipulation tool 1506 is generated with the appropriate title, description, and fields.

Referring to FIG. 18, a flow chart of a process 1800 for using a data manipulation tool for statistical analysis is shown. Process 1800 may be executed by, for example, predictive analysis system 104. Process 1800 may be executed for a second user (e.g., user 332 as shown in FIG. 3). The second user may be a user of the predictive analysis system who wishes to perform a simple statistical analysis on a set of data. The second user may or may not be the creator of the data manipulation tool.

Process 1800 includes generating a user interface including the data manipulation tool (step 1802). For example, referring also to FIG. 5, step 1802 may include generating user interface 500 and the data manipulation tool in the list of data manipulation tools 506. Process 1800 further includes receiving a user selection of the data manipulation tool (step 1804). As a result, the data manipulation tool and associated fields may be displayed to the user. For example, referring to FIG. 15, upon selecting the “quarterly forecast” data manipulation tool, data manipulation tool 1506 and field 1508 are displayed.

Process 1800 includes receiving a user input including one or more values for one or more properties (step 1806). Step 1806 may include receiving a user selection of data, such as column 1504, and a value in field 1508. Process 1800 further includes executing the algorithm associated with the data manipulation tool using the one or more values and other stored data (step 1808). For example, upon receiving the user input from the data manipulation tool, step 1804 may include determining which algorithm and components thereof to use in a statistical analysis. Process 1800 further includes formatting the results of the algorithm and generating a display including the results (step 1810).

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data, which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A computerized method use with a predictive analysis application, comprising:
using processing electronics to cause an electronic display to generate a user interface having controls for allowing a user to configure a predictive analysis chain, the predictive analysis chain including a complete set of parameters for configuration;
on the user interface, providing a user selectable option for converting the predictive analysis chain to a data manipulation tool;
using the processing electronics to convert the predictive analysis chain to the data manipulation tool, wherein the processing electronics store a subset of the complete set of parameters for configuration as requiring future user feedback; and
using the processing electronics to store the converted predictive analysis tool in memory for later selection and use in the predictive analysis application.

2. The computerized method of claim 1, further comprising:
presenting a new graphical user interface allowing for user selection of the stored data manipulation tool, and
in response to selection of the new tool, displaying a prompt for user entry of the subset of the complete set of parameters.

3. The computerized method of claim 1, wherein using the processing electronics to convert the predictive analysis chain to the data manipulation tool comprises:
presenting a user interface for receiving a user selection of which parameters of the complete set of parameters should be stored as requiring future user feedback.

4. The computerized method of claim 1, wherein the user interface for receiving a user selection of the parameters for future user feedback includes user interface controls for indicating whether the parameters can be determined based on a user selection or whether the parameter must be entered manually.

5. The computerized method of claim 4, wherein the user interface for receiving a user selection of the parameters for future user feedback allows the user to name the data manipulation tool and to provide an instructive description for the data manipulation tool.

6. The computerized method of claim 5, further comprising:
causing a test of the predictive analysis chain to be run on a first set of data prior to providing the user with the user selectable option for converting the predictive analysis chain to a data manipulation tool.

7. The computerized method of claim 6, further comprising:
storing the parameters from the test for those parameters which the processing electronics do not store with the subset of parameters requiring user feedback.

8. A system comprising:
a processor, and
a non-transitory computer-readable storage device storing instructions that, when executed by the processing module, cause the processing module to perform operations comprising:
generating a graphical user interface having controls for allowing a user to configure a predictive analysis chain, the predictive analysis chain including a complete set of parameters for configuration;
on the graphical user interface, providing a user selectable option for converting the predictive analysis chain to a data manipulation tool;
converting the predictive analysis chain to the data manipulation tool, wherein the processing module stores a subset of the complete set of parameters for configuration as requiring future user feedback; and
storing the converted predictive analysis tool in memory for later selection and use in the predictive analysis application.

9. The system of claim 8, wherein the instructions further comprise:
presenting a new graphical user interface allowing for user selection of the stored data manipulation tool, and
in response to selection of the new tool, displaying a prompt for user entry of the subset of the complete set of parameters.

10. The system of claim 8, wherein converting the predictive analysis chain to the data manipulation tool comprises:
presenting a user interface for receiving a user selection of which parameters of the complete set of parameters should be stored as requiring future user feedback.

11. The system of claim 8, wherein the user interface for receiving a user selection of the parameters for future user feedback includes user interface controls for indicating whether the parameters can be determined based on a user selection or whether the parameter must be entered manually.

12. The system of claim 11, wherein the user interface for receiving a user selection of the parameters for future user feedback allows the user to name the data manipulation tool and to provide an instructive description for the data manipulation tool.

13. The system of claim 12, wherein the instructions further comprise:
causing a test of the predictive analysis chain to be run on a first set of data prior to providing the user with the user selectable option for converting the predictive analysis chain to a data manipulation tool.

14. The system of claim 13, wherein the instructions further comprise:
storing the parameters from the test for those parameters which the processing module do not store with the subset of parameters requiring user feedback.

15. A non-transitory computer-readable storage device storing instructions that, when executed by a processor, cause the processor to perform instructions comprising:
generating a graphical user interface having controls for allowing a user to configure a predictive analysis chain, the predictive analysis chain including a complete set of parameters for configuration;
on the graphical user interface, providing a user selectable option for converting the predictive analysis chain to a data manipulation tool;
converting the predictive analysis chain to the data manipulation tool, wherein the processor stores a subset of the complete set of parameters for configuration as requiring future user feedback; and
storing the converted predictive analysis tool in memory for later selection and use in the predictive analysis application.

16. The non-transitory computer-readable storage device of claim 15, wherein the instructions further comprise:
presenting a new graphical user interface allowing for user selection of the stored data manipulation tool, and
in response to selection of the new tool, displaying a prompt for user entry of the subset of the complete set of parameters.

17. The non-transitory computer-readable storage device of claim 15, wherein converting the predictive analysis chain to the data manipulation tool comprises:
presenting a user interface for receiving a user selection of which parameters of the complete set of parameters should be stored as requiring future user feedback.

18. The non-transitory computer-readable storage device of claim 17, wherein the user interface for receiving a user selection of the parameters for future user feedback includes user interface controls for indicating whether the parameters can be determined based on a user selection or whether the parameter must be entered manually.

19. The non-transitory computer-readable storage device of claim 18, wherein the user interface for receiving a user selection of the parameters for future user feedback allows the user to name the data manipulation tool and to provide an instructive description for the data manipulation tool.

20. The non-transitory computer-readable storage device of claim 19, wherein the instructions further comprise:
causing a test of the predictive analysis chain to be run on a first set of data prior to providing the user with the user selectable option for converting the predictive analysis chain to a data manipulation tool; and
storing the parameters from the test for those parameters which the processor does not store with the subset of parameters requiring user feedback.
